(19) United States
(12) Patent Application Publication
(10) Pub. No.: US 2019/0037184 A1
(43) Pub. Date: Jan. 31, 2019

(54) Projection Display Apparatus

(71) Applicant: Ravi Gauba, Mountain View, CA (US)

(72) Inventor: Ravi Gauba, Mountain View, CA (US)

(21) Appl. No.: 15/662,593

(22) Filed: Jul. 28, 2017

(51) Int. Cl. H04N 9/31; H04N 5/232

(52) U.S. Cl. CPC H04N 9/3179; H04N 9/3147; G03B 21/006; H04N 5/23238; H04N 9/317; H04N 9/3194

(57) ABSTRACT

A projection display apparatus including a display screen, one or more projectors operably connected to a visual source and mounted, in an embodiment, via a projector mount, and an electronic control unit operably coupled to the projectors, is provided for displaying visual content free of a screen door effect. The projectors generate and render a front projection and/or a rear projection of visual content received from the visual source to the display screen with a field of view defined by a size of the display screen. The electronic control unit controls user input, detects and projects the visual content in focus on the display screen via the projectors, performs quality adjustment of the visual content, defines an area of the visual content to project on the display screen with the defined field of view, and in an embodiment, tracks movement of a user's head.

### BACKGROUND

Conventional virtual reality headsets have a liquid crystal display (LCD), or a light emitting diode (LED) display, or an equivalent display native to the headset, or a mobile display to display content, and typically need a lens to focus the visual content on the display. The conventional virtual reality headsets produce a screen door effect. The screen door effect refers, for example, to fine lines, dark spots, or spaces visible between pixels of content displayed on the display, as if the displayed content is being viewed through a screen door. The LCD and/or the LED display of conventional virtual reality headsets have physical limitations on how close pixels of visual content can be placed. Moreover, the spacing between the pixels is displayed as black dots that are easily visible and distracting, causing the screen door effect that lowers the immersive experience of the user.

Furthermore, the liquid crystal display (LCD) of a conventional virtual reality headset displays only a portion or a subsection of visual content focused by a lens. A viewport in a virtual reality headset shows only a part of visual content, for example, an image displayed on the display. The displayed portion or the subsection of the visual content being shown on the LCD changes according to movement of a user's head. The visual content needs to track the movement of the user's head accurately with a high frame rate, and content and viewing angle need to be synched to both eyes so that the visual content updates correctly. The conventional virtual reality headsets need high frame rates, for example, 60 frames per second or more to reduce jitter and lag and to avoid a user from becoming motion sick. Jitter and lag cause disorientation and motion sickness.

Moreover, lens based projectors of conventional virtual reality headsets can only focus at one specific distance and cannot maintain focus across a curved surface. Furthermore, a conventional virtual reality head mounted display does not have a full field of view, but has a restricted field of view that in turn limits a full immersive viewing experience of a user. Humans have about a 180 degree horizontal viewing angle and a 135 degree vertical viewing angle. In conventional virtual reality headsets, the viewing angle is restricted, for example, to about 120 degrees. The above issues diminish the virtual reality experience of an end user if required calibrations are not performed accurately.

Hence, there is a long felt need for a projection display apparatus for projecting and displaying visual content in focus on a display screen with a field of view defined by the size of the display screen, free of the screen door effect to provide an enhanced immersive viewing experience to a user. Moreover, there is a need for a projection display apparatus that tracks movement of the user's head when the visual content is projected on a display screen having less than a 360 degree field of view to reduce jitter and lag and to avoid motion sickness. Furthermore, there is a need for a projection display apparatus that reduces requirements on strict calibration needed for the visual content displayed for each of the user's eyes based on the movement of the user's head that can lead to motion sickness, a ghosting effect, or out of focus images displayed between both the user's eyes.

### SUMMARY OF THE INVENTION

This summary is provided to introduce a selection of concepts in a simplified form that are further disclosed in the detailed description of the invention. This summary is not intended to determine the scope of the claimed subject matter.

The apparatus disclosed herein addresses the above recited need for a projection display apparatus for projecting and displaying visual content in focus on a display screen with a field of view defined by a size of the display screen, free of a screen door effect to provide an enhanced immersive viewing experience to a user. The projection display apparatus tracks movement of the user's head when the visual content is projected on a display screen having less than a 360 degree field of view to reduce jitter and lag and to avoid motion sickness. The projection display apparatus disclosed herein reduces requirements on strict calibration needed for the visual content displayed for each of the user's eyes based on the movement of the user's head that can lead to motion sickness, a ghosting effect, or out of focus images displayed between both the user's eyes.

The projection display apparatus disclosed herein comprises a display screen, one or more projectors, and an electronic control unit. One or more projectors are operably positioned with respect to the display screen and operably connected to a visual source. The visual source, for example, a mobile phone, a camera, etc., provides visual content to the projectors. The projectors generate and render a front projection and/or a rear projection of the visual content received from the visual source to the display screen with a field of view defined by the size of the display screen. The electronic control unit is operably coupled to the projectors. The electronic control unit controls user input, detects and projects the visual content in focus on the display screen via the projectors, performs quality adjustment of the visual content, and defines an area of the visual content to project on the display screen with the field of view defined by the size of the display screen for providing a full immersive viewing experience to the user.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific components and structures disclosed herein. The description of a component or a structure referenced by a numeral in a drawing is applicable to the description of that component or structure shown by that same numeral in any subsequent drawing herein.

FIGS. 1A-1D exemplarily illustrate top plan views of different embodiments of a projection display apparatus for displaying visual content free of a screen door effect.

FIGS. 2A-2E exemplarily illustrate different embodiments of the projection display apparatus.

FIGS. 3A-3B exemplarily illustrate block diagrams showing implementations of the projection display apparatus.

FIG. 4 exemplarily illustrates a block diagram showing another implementation of the projection display apparatus.

### DETAILED DESCRIPTION OF THE INVENTION

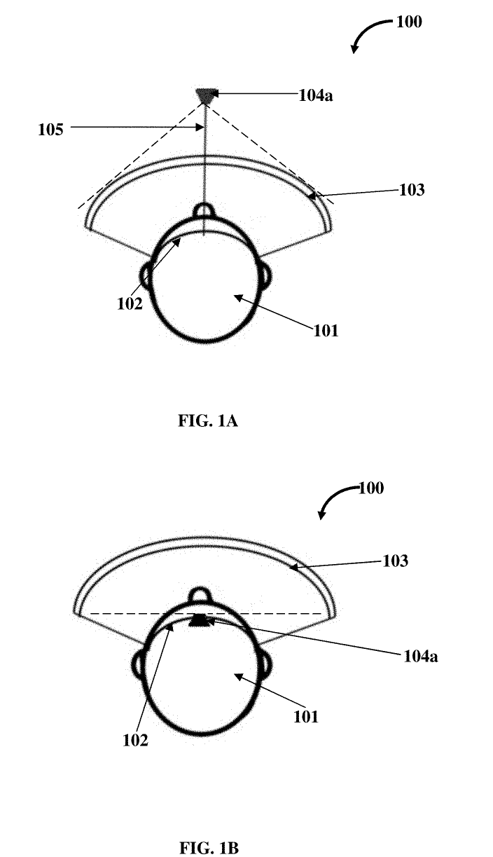

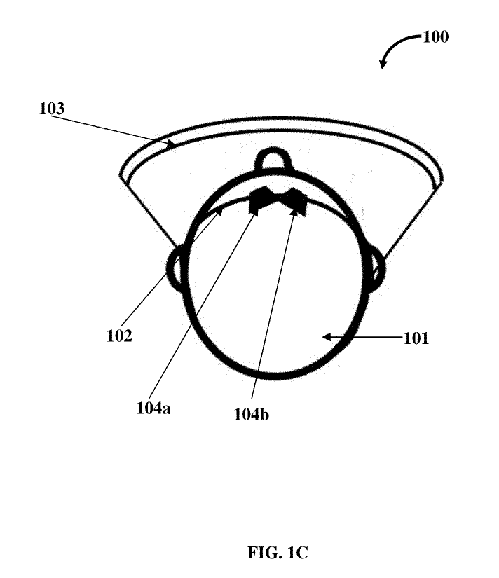

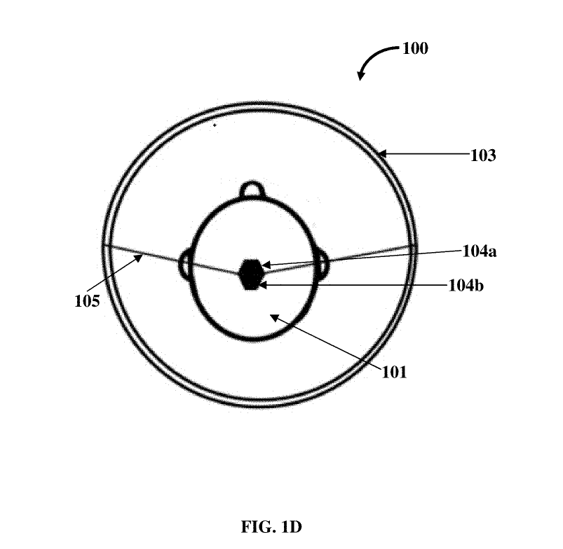

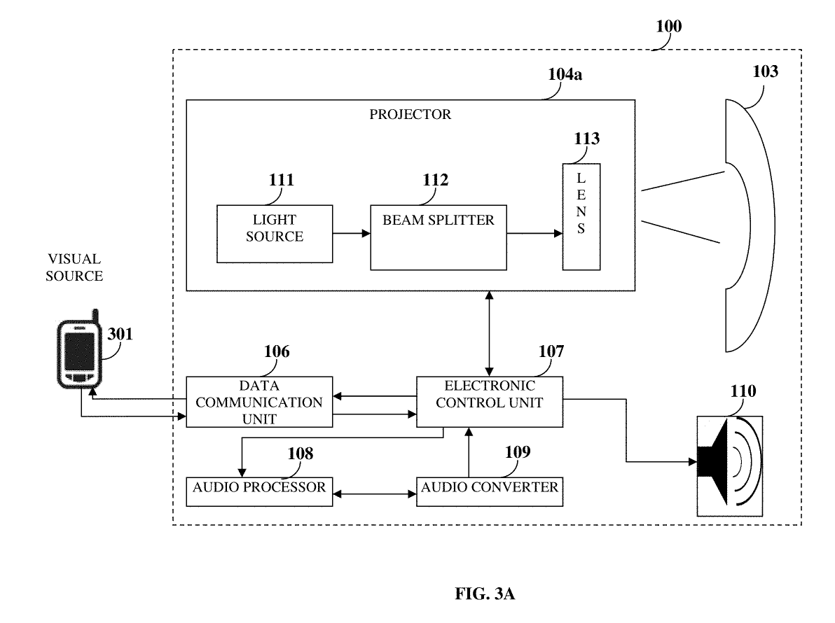

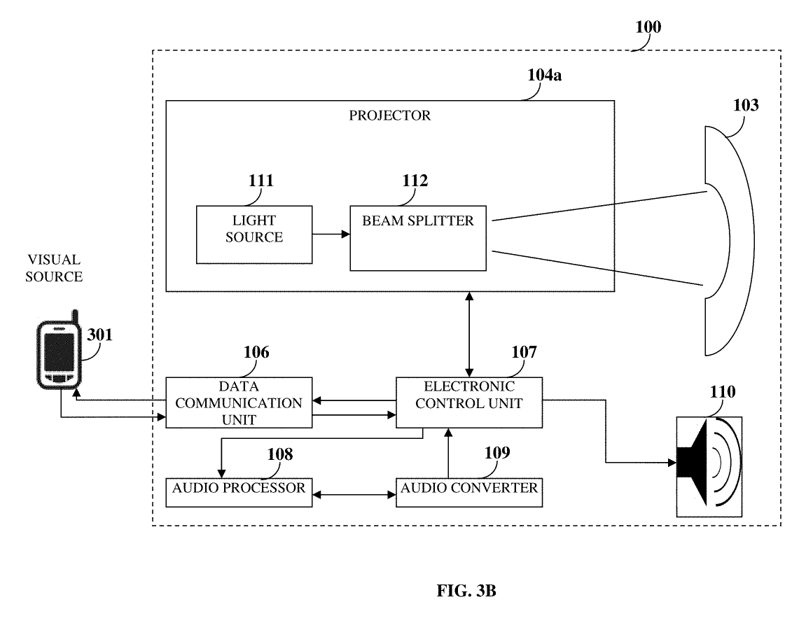

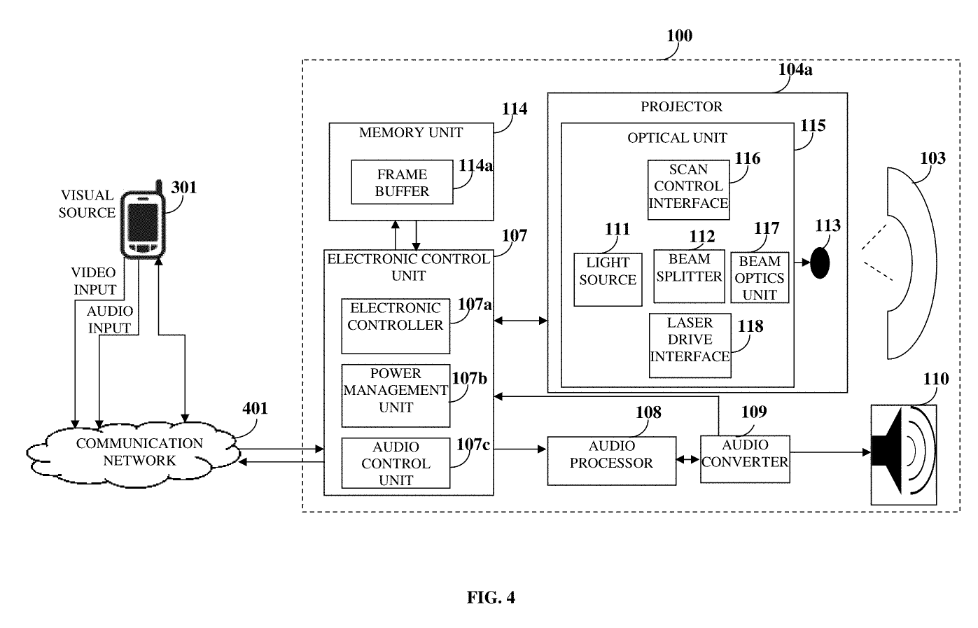

FIGS. 1A-1D exemplarily illustrate top plan views of different embodiments of a projection display apparatus 100 for displaying visual content free of a screen door effect. In an embodiment, the projection display apparatus 100 is mounted on a user's head 101 as exemplarily illustrated in FIGS. 1A-1D. The projection display apparatus 100 disclosed herein comprises a display screen 103 exemplarily illustrated in FIGS. 1A-1D, one or more projectors 104a and 104b exemplarily illustrated in FIGS. 1A-1D, and an electronic control unit 107 exemplarily illustrated in FIGS. 3A-4. In an embodiment as exemplarily illustrated in FIGS. 1A-1C, the projection display apparatus 100 further comprises a head mount 102 on which the display screen 103 is mounted. The projectors 104a and 104b are operably connected to a visual source 301 as exemplarily illustrated in FIGS. 3A-4. In an embodiment, the visual source 301 is integrated in the projection display apparatus 100. In an embodiment, the visual source 301, for example, a camera, a mobile phone, etc., renders visual content comprising, for example, video content to the projectors 104a and 104b via the electronic control unit 107. In another embodiment, the visual source 301 is directly connected to the projectors 104a and 104b. In an embodiment, the visual source 301 renders other media content comprising, for example, digital audio content, audiovisual content, etc., to the projectors 104a and 104b. The display screen 103 can be positioned stationary around the user's head 101 or mounted on the user's head 101 in front of the user's face using the head mount 102 as exemplarily illustrated in FIGS. 1A-1C.

The projectors 104a and 104b are operably positioned with respect to the display screen 103. The projectors 104a and 104b are, for example, laser projectors or light emitting diode (LED) based projectors with in focus technology for focusing the visual content on the display screen 103. In an embodiment, a projector 104a is connected to the head mount 102 and mounted behind the display screen 103 as exemplarily illustrated in FIG. 1A, for a rear projection of the visual content on the display screen 103. In another embodiment, a projector 104a is connected to the head mount 102 and mounted facing the display screen 103 as exemplarily illustrated in FIG. 1B, for a front projection of the visual content on the display screen 103. The projectors 104a and 104b generate and render a front projection and/or a rear projection of the visual content received from the visual source 301 to the display screen 103 with a field of view defined by the size of the display screen 103. In an embodiment as exemplarily illustrated in FIG. 1D, the projection display apparatus 100 further comprises a projector mount 105 positioned on the user's head 101. The projector mount 105 mounts the projectors 104a and 104b on the user. In an embodiment, the projector mount 105 is a clamp that clamps the projectors 104. In another embodiment, the projector mount 105 is a fitting that mounts the projectors 104a and 104b on the user. The projector mount 105 can be mounted on the front side of the user for a front projection of the visual content or on the rear side of the user for a rear projection of the visual content.

The projectors 104a and 104b project the visual content on the display screen 103 and as the light on the surface of the display screen 103 disperses, the light blends to avoid any screen door effect. The screen door effect occurs in a liquid crystal display (LCD) screen because the visual content displayed on the LCD screen is substantially scaled by a lens, which makes the spacing between light emitting diodes (LEDs) in the LCD screen visible as dark spots or lines. The projection of the visual content on the display screen 103 by the projectors 104a and 104b of the projection display apparatus 100 disclosed herein removes the screen door effect as the projection causes brightness of a pixel in the visual content to diffuse into a neighboring pixel and blur the pixels together. The projectors 104a and 104b can project the complete visual content, for example, a full video on a 360 degree dome shaped display screen 103 which eliminates the need to synchronize the video with a user's head movements. The video remains in focus on the curved surface of the 360 degree dome shaped display screen 103 by using one or more laser or other projectors 104a and 104b that can keep the focus on a curved surface. The projectors 104a and 104b render a presentation of the video on the display screen 103 independent of the movement of the user's head 101, while still providing a full immersive 360 degree experience and avoiding motion sickness. The projectors 104a and 104b project the visual content on a curved surface of the display screen 103 with a much larger viewing angle of 180 degrees or more, free of the screen door effect because of natural blurring of light from one pixel to the next pixel with the projectors 104a and 104b.

In an embodiment, the electronic control unit 107 is operably coupled to the projectors 104a and 104b. The electronic control unit 107 controls user input, detects and projects the visual content in focus on the display screen 103 via the projectors 104a and 104b, performs quality adjustment of the visual content, and defines an area of the visual content to project on the display screen 103 with the field of view defined by the size of the display screen 103 based on the position of the user's head 101 for providing a full immersive viewing experience to the user as disclosed in the detailed description of FIGS. 3A-4. In an embodiment for a display screen 103 having less than a 360 degree field of view as exemplarily illustrated in FIGS. 1A-1C, the electronic control unit 107 performs calibration and tracking of the movement of the user's head 101. In this embodiment, when the projectors 104a and 104b generate and render the front projection and/or the rear projection of the visual content to the display screen 103 having less than a 360 degree field of view, the electronic control unit 107 tracks movement of the user's head 101. In an embodiment where the display screen 103 has less than a 360 degree field of view, the electronic control unit 107 tracks the movement of the user's head 101 while excluding the location between the two eyes of the user. The electronic control unit 107 allows the movement of the user's head 101 to be tracked accurately and synchronizes the visual content and viewing angle to both eyes of the user so that the visual content updates correctly on the display screen 103.

In an embodiment, the electronic control unit 107 is operably connected to the visual source 301 via a connection interface (not shown), for example, a wired connection interface, a wireless connection interface, or any combination thereof, for transmitting an electronic signal to the visual source 301 to deliver the visual content to the projectors 104a and 104b for the generation and the rendering of the front projection and/or the rear projection of the visual content to the display screen 103. The connection interface of the electronic control unit 107 provides a wired connection or a wireless connection to the visual source 301 to deliver an electronic signal to the visual source 301 to deliver the visual content to be projected on the display screen 103 via the projectors 104a and 104b. The projection display apparatus 100 disclosed herein is electrically connected to a power supply, for example, a battery for running the projectors 104a and 104b and/or the electronic control unit 107.

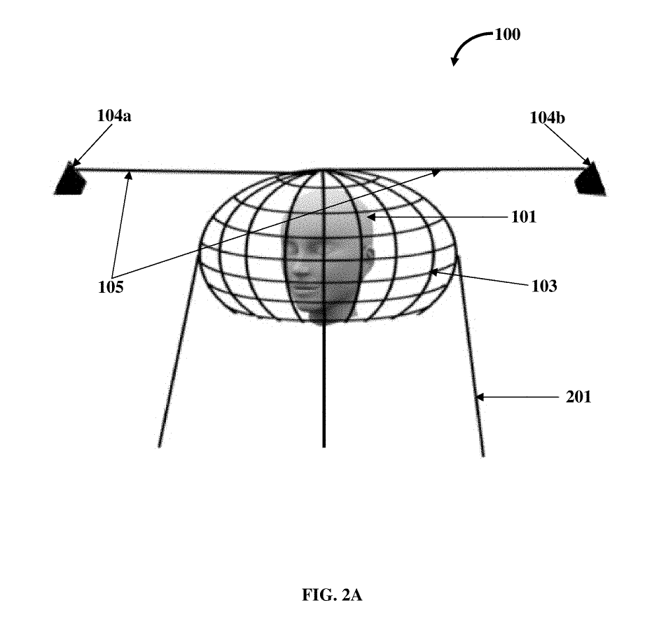

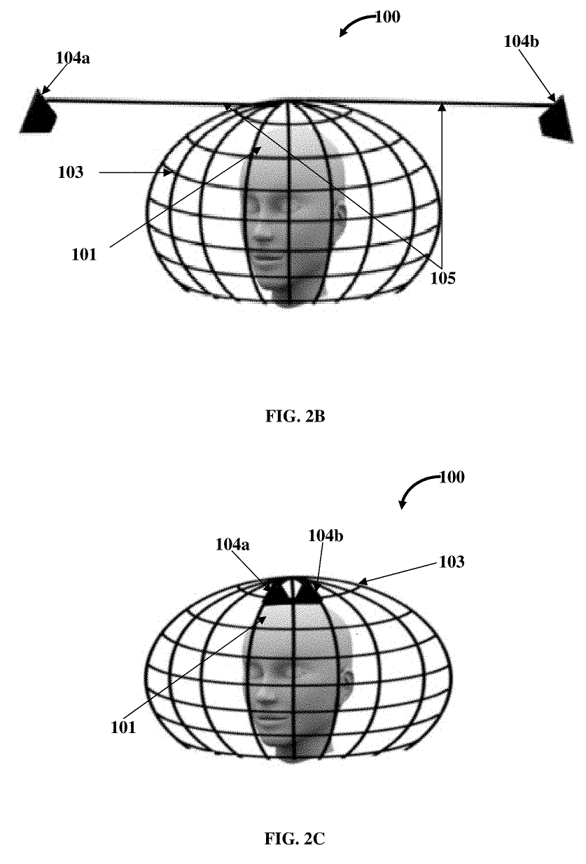

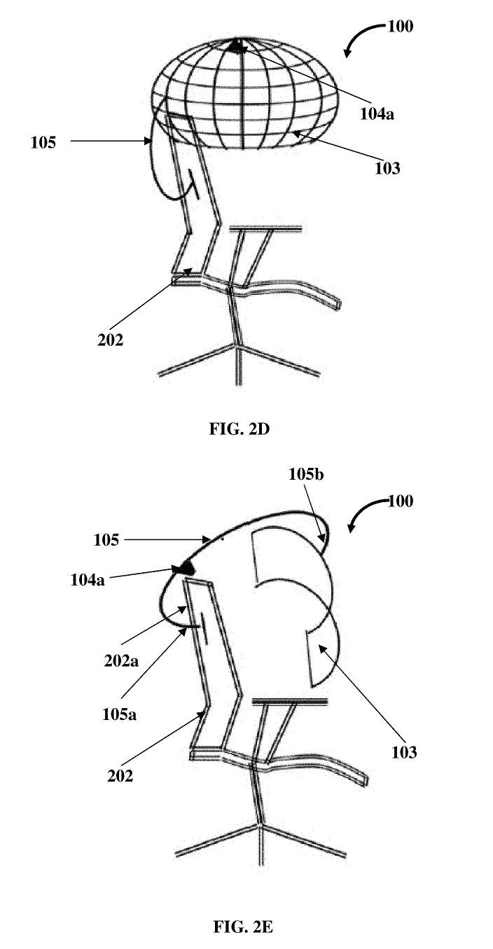

The display screen 103 is mounted on the head mount 102 as exemplarily illustrated in FIGS. 1A-1C. In an embodiment, the head mount 102 is configured as a strap. As exemplarily illustrated in FIG. 1A, a projector 104a is positioned on the projector mount 105 to mount the projector 104a at a rear location behind the display screen 103 for the generation of the rear projection of the visual content on the display screen 103. In another embodiment, the projector 104a is positioned on the head mount 102 at a front location with respect to the display screen 103 as exemplarily illustrated in FIG. 1B, for the generation of the front projection of the visual content on the display screen 103. The display screen 103 can have multiple shapes and sizes. As exemplarily illustrated in FIGS. 1A-1B, the display screen 103 is configured as a visor attached to the user's head 101. As the user's head 101 moves, the display screen 103 with the projected visual content, for example, an image moves with the head 101 to provide a full 360 degree view of the projected visual content to the user. In an embodiment, the display screen 103 is configured as a partial dome shaped display screen or a curved display screen attached to the head mount 102. In another embodiment as exemplarily illustrated in FIGS. 2A-2D, the display screen 103 is configured as a head mountable dome shaped display screen that encompasses the user's head 101 and rests on the user's shoulder. The dome shaped display screen 103 rests on the user's shoulder so that the user can move the head 101 without the dome shaped display screen 103 moving. The dome shaped display screen 103 is mounted over the user's head 101, allows the user's head 101 to move freely, and provides a full immersive experience to the user. In another embodiment, the display screen 103 is configured as eyeglasses and is connected to the head mount 102 as exemplarily illustrated in FIG. 1C. The projection display apparatus 100 disclosed herein displays the visual content on the display screen 103 with a larger viewing angle of 180 degrees or more. The projection display apparatus 100 reduces the screen door effect, that is, reduces fine lines visible between pixels of visual content displayed on the display screen 103, due to natural blurring of light with the projectors 104a and 104b.

In another embodiment, the display screen 103 of the projection display apparatus 100 is mounted on the user's shoulder as exemplarily illustrated in FIG. 1D. In this embodiment, the projection display apparatus 100 displays the visual content on the display screen 103 independent of the movement of the user's head 101, while still providing the full immersive 360 degree experience to the user. In this embodiment, the projection display apparatus 100 is built with a circular or spherical display screen 103 that rests on the user's shoulders. The display screen 103 is made of different materials, for example, paper, cloth, plastic, etc. In an embodiment, the display screen 103 is opaque. In another embodiment, the display screen 103 is translucent. The projection display apparatus 100 disclosed herein is used, for example, in virtual reality, augmented reality, applications such as gaming, viewing of 360 degree content containing both images and videos, and in toys and educational systems such as a personal planetarium. One or more of the projectors 104a and 104b of the projection display apparatus 100 disclosed herein project the visual content on the display screen 103 for a personalized viewing experience.

FIGS. 2A-2E exemplarily illustrate different embodiments of the projection display apparatus 100. In an embodiment, the display screen 103 is configured, for example, as a full sphere display screen or a full dome shaped display screen mounted on a stand 201 as exemplarily illustrated in FIG. 2A, or over the user's head 101 as exemplarily illustrated in FIGS. 2B-2C, which allows the user's head 101 to move freely and have a full immersive experience. In an embodiment, the projectors 104a and 104b of the projection display apparatus 100 are positioned outside the dome shaped display screen 103 using the projector mounts 105 that extend in opposing directions from the dome shaped display screen 103, while the dome shaped display screen 103 that surrounds the user's head 101 is mounted on a stand 201 as exemplarily illustrated in FIG. 2A. The stand 201 is mounted on a ground surface as exemplarily illustrated in FIG. 2A. In another embodiment, the projectors 104a and 104b are positioned outside the dome shaped display screen 103 using the projector mounts 105 as exemplarily illustrated in FIG. 2B, for a rear projection of the visual content on the dome shaped display screen 103. In another embodiment, the projectors 104a and 104b are positioned inside the dome shaped display screen 103 as exemplarily illustrated in FIG. 2C, for a front projection of the visual content on the dome shaped display screen 103. As exemplarily illustrated in FIGS. 2A-2C, the user places his/her head 101 inside the dome shaped display screen 103. In an embodiment, when a display screen 103 having a 360 degree field of view, for example, a full 360 degree sphere or dome shaped display screen 103 is used in the projection display apparatus 100, the projectors 104a and 104b project the visual content on the full 360 degree sphere shaped display screen 103 without requiring the electronic control unit 107 exemplarily illustrated in FIGS. 3A-4, to track the movement of the user's head 101.

In another embodiment as exemplarily illustrated in the FIG. 2D, a dome shaped display screen 103 with a projector 104a is mounted on a chair 202. In another embodiment as exemplarily illustrated in the FIG. 2E, a curved display screen 103 with the projector 104a is mounted on a chair 202. In this embodiment, one end 105a of the projector mount 105 is connected to an upper section 202a of the chair 202 for mounting the projector 104a as exemplarily illustrated in FIG. 2E, while the other end 105b of the projector mount 105 is connected to the curved display screen 103 as exemplarily illustrated in FIG. 2E.

FIGS. 3A-3B exemplarily illustrate block diagrams showing implementations of the projection display apparatus 100. The projection display apparatus 100 disclosed herein comprises the electronic control unit 107, the projector 104a, and the display screen 103 as disclosed in the detailed description of FIGS. 1A-1D and FIGS. 2A-2E. In an embodiment, the projection display apparatus 100 disclosed herein further comprises a data communication unit 106 for transmitting information from a visual source 301 to the electronic control unit 107. In an embodiment, the data communication unit 106 transmits information from the visual source 301 to the electronic control unit 107 via a communication network, for example, a wired communication network, a wireless communication network, or any combination thereof. For example, as the user's head 101 exemplarily illustrated in FIGS. 1A-1D and FIGS. 2A-2C, moves, the data communication unit 106 transmits tracking information of the movement of the user's head 101 to the electronic control unit 107 to accurately move the visual content on the display screen 103 to provide a full immersive experience to the user. The visual source 301 renders visual content to the data communication unit 106. The visual source 301 is, for example, a computing device, for example, one or more of a personal computer, a tablet computing device, a mobile computer, a mobile phone, a smart phone, a portable computing device, a laptop, a personal digital assistant, a wearable device such as the Google Glass® of Google Inc., the Apple Watch® of Apple Inc., etc., a touch centric device, a workstation, a client device, a portable electronic device, a network enabled computing device, an interactive network enabled communication device, a gaming device, a set top box, a television, an image capture device such as a camera, a web browser, a portable media player, a disc player such as a Blu-ray Disc® player of the Blu-ray Disc Association, a video recorder, an audio recorder, a global positioning system (GPS) device, a theater system, any entertainment system, any other suitable computing equipment, combinations of multiple pieces of computing equipment, etc. The visual content comprises, for example, video content, digital audiovisual content, etc.

In an embodiment, the projection display apparatus 100 is integrated with one or more audio units 110, for example, speakers operably coupled to the electronic control unit 107 for rendering audio synchronized with the visual content projected on the display screen 103 and for enhancing the user's experience as exemplarily illustrated in FIGS. 3A-3B. In an embodiment, the audio units 110 are located around the display screen 103. In another embodiment, the audio units 110 are operably coupled to the head mount 102 exemplarily illustrated in FIGS. 1A-1C. In another embodiment, the audio units 110 are incorporated in a wireless headset. In an embodiment, the projection display apparatus 100 is built to fold for easy transportation and storage.

As exemplarily illustrated in FIGS. 3A-3B, the data communication unit 106 is operably connected to the electronic control unit 107. The data communication unit 106 transmits the visual content received from the visual source 301 to the electronic control unit 107. The electronic control unit 107 controls the received visual content, for example, based on the user input, or by detecting and projecting the visual content in focus on the display screen 103 via the projector 104a, or by performing quality adjustment of the visual content, or by defining an area of the visual content to project on the display screen 103 with the field of view defined by the size of the display screen 103 for providing a full immersive viewing experience to the user. The electronic control unit 107 performs quality adjustment of the visual content by processing input visual content based on, for example, type of the visual content such as video type, presets configured to render the visual content in focus on a non-flat display screen, etc. In an embodiment, the electronic control unit 107 dynamically calculates the position of the user's head 101 and the area of the input visual content being focused on by the user and projects the focused input visual content on the display screen 103 within the field of view defined by the size of the display screen 103 via the projector 104a.

In an embodiment, the electronic control unit 107 is operably coupled to an audio processor 108 and an audio convertor 109. The audio processor 108 processes digital audio signals provided by the visual source 301 and received from the electronic control unit 107. The audio processor 108 alters the digital audio signals through an audio effect and electronically represents the audio signal in a digital format or an analog format. The audio converter 109 receives the processed digital audio signals and converts the processed digital audio signals into different audio formats. The audio convertor 109 transmits the converted digital audio signals back to the electronic control unit 107. The electronic control unit 107 transmits the processed audio signals along with the visual content to the projector 104a for synchronizing the audio with the visual content displayed on the display screen 103.

As exemplarily illustrated in FIGS. 3A-3B, the projector 104a comprises a light source 111 and a beam splitter 112. The light source 111 is an accelerator that produces a substantially intense beam of light for facilitating display of the visual content on the display screen 103 by the projector 104a. The beam splitter 112, for example, in the form of one or more light splitting mirrors, receives the light beam produced by the light source 111. The beam splitter 112 is an optical device that splits the light beam into two or more beams. In an embodiment, based on the type of projector 104a used, the projection display apparatus 100 disclosed herein further comprises one or more lenses 113 operably coupled in or to the projector 104a for focusing and projecting the visual content on the display screen 103. In an embodiment as exemplarily illustrated in FIG. 3A, the projector 104a further comprises a lens 113. The beam splitter 112 of the projector 104a transmits the split light beam to the lens 113. The lens 113 is located in front of the light source 111 of the projector 104a as exemplarily illustrated in FIG. 3A.

The lens 113 projects the visual content received from the visual source 301 in focus on the display screen 103. In an embodiment, the lens 113 is used to zoom in and zoom out of the visual content to maintain the displayed visual content in focus on the display screen 103. In another embodiment, the projector 104a is configurably positioned at a distance from the display screen 103 to zoom in and zoom out of the visual content to maintain the displayed visual content in focus on the display screen 103. The lens 113 facilitates focusing of the visual content on the display screen 103 by the projector 104a. The projector 104a projects the visual content on the display screen 103 and as the light on the surface of the display screen 103 disperses, the light blends to avoid any screen door effect. In an embodiment, the projector 104a is a laser projector with the lens 113 as exemplarily illustrated in FIG. 3A. The lens 113 in the projector 104a converges a color beam of the visual content that is split by the beam splitter 112, based on the color of the visual content to be rendered on the display screen 103 by the projector 104a. In another embodiment as exemplarily illustrated in FIG. 3B, the projector 104a is a laser projector without the lens 113. In this embodiment, a laser of the projector 104a produces a focused beam of light for displaying the visual content on the display screen 103 as exemplarily illustrated in FIG. 3B.

FIG. 4 exemplarily illustrates a block diagram showing another implementation of the projection display apparatus 100. In an embodiment as exemplarily illustrated in FIG. 4, in addition to the display screen 103, the projector 104a, and the electronic control unit 107, the projection display apparatus 100 disclosed herein further comprises a memory unit 114, an audio processor 108, an audio convertor 109, and an audio unit 110. A visual source 301 renders input visual content comprising, for example, input video content and input audio content to the electronic control unit 107 via a communication network 401. The communication network 401 is, for example, one of the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, etc., a local area network, a wide area network, an internet connection network, an infrared communication network, etc., or a network formed from any combination of these networks.

The memory unit 114 of the projection display apparatus 100 disclosed herein comprises a frame buffer 114a. The frame buffer 114a stores complete frames of the visual content received from the electronic control unit 107. The electronic control unit 107 receives the input visual content and based on the position of the user's head 101 exemplarily illustrated in FIGS. 1A-1D and FIGS. 2A-2C, computes a video region to be rendered on the display screen 103. The electronic control unit 107 processes and transmits the computed video region to the frame buffer 114a. The electronic control unit 107 communicates with the frame buffer 114a to receive the complete frames of the visual content and the computed video region and transmits the visual content to the projector 104a for display on the display screen 103. The electronic control unit 107 comprises an electronic controller 107a, a power management unit 107b, and an audio control unit 107c. The electronic controller 107a controls user input, detects and projects the visual content in focus on the display screen 103 via the projector 104a, performs quality adjustment of the visual content, and defines an area of the visual content to project on the display screen 103 with the field of view defined by the size of the display screen 103. The audio control unit 107c controls the digital audio signals of the visual content received from the visual source 301 via the communication network 401. The audio control unit 107c is operably connected to the audio processor 108 and the audio convertor 109. The audio control unit 107c contains audio specific information. The audio control unit 107c transmits the audio specific information to the audio processor 108. Using the audio specific information, the audio processor 108 alters the digital audio signals as disclosed in the detailed description of FIGS. 3A-3B. The audio converter 109 converts the digital audio signals into different audio formats. The audio processor 108 and the audio convertor 109 process and convert the digital audio signals received from the audio control unit 107c respectively, and transmit the processed digital audio signals back to the audio control unit 107c. The electronic control unit 107 transmits the processed audio signals along with the visual content to the projector 104a for synchronizing audio with the visual content displayed on the display screen 103.

The power management unit 107b of the electronic control unit 107 controls the voltage received from an external power supply (not shown) and transmits the voltage to the optical unit 115 of the projector 104a. The optical unit 115 comprises the light source 111, the beam splitter 112, a beam optics unit 117, a scan control interface 116, and a laser drive interface 118. The light source 111 of the optical unit 115 receives the controlled voltage from the power management unit 107b. The beam splitter 112 receives the light beam produced by the light source 111. The beam splitter 112 splits the received light beam into two or more light beams for displaying the visual content on the display screen 103. The beam optics unit 117 provides the path of propagation for the light beam via the laser drive interface 118. The scan control interface 116 controls the light beam propagation to the display screen 103. The optical unit 115 transmits the light beam to the lens 113 located in front of the optical unit 115. The lens 113 facilitates focusing of the visual content on the display screen 103 by the projector 104a.

The foregoing examples have been provided merely for the purpose of explanation and are in no way to be construed as limiting of the projection display apparatus 100 disclosed herein. While the projection display apparatus 100 has been described with reference to various embodiments, it is understood that the words, which have been used herein, are words of description and illustration, rather than words of limitation. Furthermore, although the projection display apparatus 100 has been described herein with reference to particular means, materials, and embodiments, the projection display apparatus 100 is not intended to be limited to the particulars disclosed herein; rather, the projection display apparatus 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the projection display apparatus 100 disclosed herein in its aspects.

I claim:

1. A projection display apparatus for displaying visual content free of a screen door effect, said projection display apparatus comprising:
a display screen;
one or more projectors operably positioned with respect to said display screen and operably connected to a visual source, for generating and rendering one or more of a front projection and a rear projection of visual content received from said visual source to said display screen with a field of view defined by a size of said display screen; and
an electronic control unit operably coupled to said one or more projectors for controlling user input, detecting and projecting said visual content in focus on said display screen via said one or more projectors, performing quality adjustment of said visual content, and defining an area of said visual content to project on said display screen with said field of view defined by said size of said display screen.

2. The projection display apparatus of claim 1, further comprising one or more lenses operably coupled to said one or more projectors for focusing and projecting said visual content on said display screen.

3. The projection display apparatus of claim 1, wherein said electronic control unit tracks movement of a head of a user when said one or more projectors generate and render said one or more of said front projection and said rear projection of said visual content to said display screen having less than a 360 degree field of view.

4. The projection display apparatus of claim 1, wherein said one or more projectors project said visual content on said display screen having a 360 degree field of view without requiring said electronic control unit to track movement of a head of a user.

5. The projection display apparatus of claim 1, wherein said electronic control unit is operably connected to said visual source via a connection interface for transmitting an electronic signal to said visual source to deliver said visual content to said one or more projectors for said generation and said rendering of said one or more of said front projection and said rear projection of said visual content to said display screen.

6. The projection display apparatus of claim 1 electrically connected to a power supply.

7. The projection display apparatus of claim 1, wherein said display screen is one of a curved display screen, a full sphere display screen, a dome shaped display screen, and a partial dome shaped display screen.

8. The projection display apparatus of claim 1, wherein said display screen is mounted on one of a head mount, a shoulder of a user, a stand, a chair, and a ground surface.

9. The projection display apparatus of claim 1, further comprising a projector mount positioned on one of a head of a user and a chair for mounting said one or more projectors.

10. The projection display apparatus of claim 1, wherein said one or more projectors are positioned at one of a front location and a rear location with respect to said display screen for said generation of one of said front projection and said rear projection of said visual content respectively.

11. The projection display apparatus of claim 1, further comprising one or more audio units operably coupled to said electronic control unit for rendering audio synchronized with said visual content projected on said display screen.
